(19) United States
(12) Patent Application Publication
(10) Pub. No.: US 2013/0148011 A1
(43) Pub. Date: Jun. 13, 2013

(54) VOICE COIL MOTOR FOR A LENS MODULE

(71) Applicant: TZU-NAN CHOU, Tu-Cheng (TW)

(72) Inventor: TZU-NAN CHOU, Tu-Cheng (TW)

(73) Assignee: HON HAI PRECISION INDUSTRY CO., LTD., Tu-Cheng (TW)

(21) Appl. No.: 13/446,193

(22) Filed: Apr. 13, 2012

(30) Foreign Application Priority Data
Dec. 8, 2011 (TW) 100145403

(51) Int. Cl. H04N 5/232; H02K 41/03

(52) U.S. Cl. 348/357; 310/12.16; 348/E05.045

(57) ABSTRACT

A voice coil motor includes a fixing assembly and a piston assembly movably received in the fixing assembly. The fixing assembly includes a fixing frame and one or more magnetic members positioned on the fixing frame. The piston assembly includes a lens and a coil sleeved on the lens. The coil and the lens cooperatively define a receiving groove. The fixing frame forms one or more resisting portions. The fixing frame sleeves on the lens with the resisting portions engaging in the receiving groove, such that the coil together with the lens is capable of moving along the at least one resisting portion utilizing the magnetic force generated by the magnetic members.

### BACKGROUND

1. Technical Field

The present disclosure generally relates to voice coil motors, and particularly to a voice coil motor for a lens module.

2. Description of the Related Art

A voice coil motor has a small size, small power consumption and is of a low price, thus the voice coil motor is suitable for zooming or focusing a camera module. The voice coil motor includes a fixing assembly, rotary assembly positioned in the fixing assembly, and a plurality of magnetic members. In assembly of the camera module, the voice coil motor is fixed on the image sensor, and then, a barrel of the lens module is screwed into the rotary assembly. However, a threaded portion(s) needs to be formed in the rotary assembly and the barrel of the lens module, therefore, the voice coil motor is difficult to manufacture. In addition, in assembly of the camera module, an operator must spend a significant amount of time manually screwing the lens module into place, thereby resulting in lower assembly efficiency.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric, assembled view of an embodiment of a lens module including a support assembly, a piston assembly, and a fixing assembly.

FIG. 2 is an isometric, exploded view of the lens module of FIG. 1.

FIG. 3 is similar to FIG. 2, but viewed from another aspect.

FIG. 4 is an isometric, exploded view of the support assembly of FIG. 3.

FIG. 5 is an isometric, exploded view of the piston assembly of FIG. 3.

FIG. 6 is an isometric, exploded view of the fixing assembly of FIG. 3.

### DETAILED DESCRIPTION

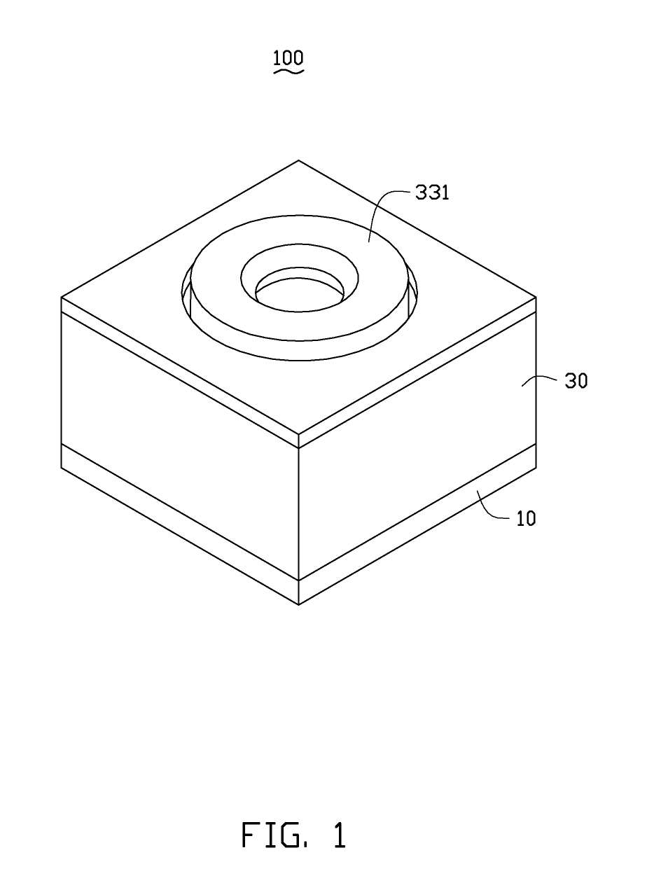

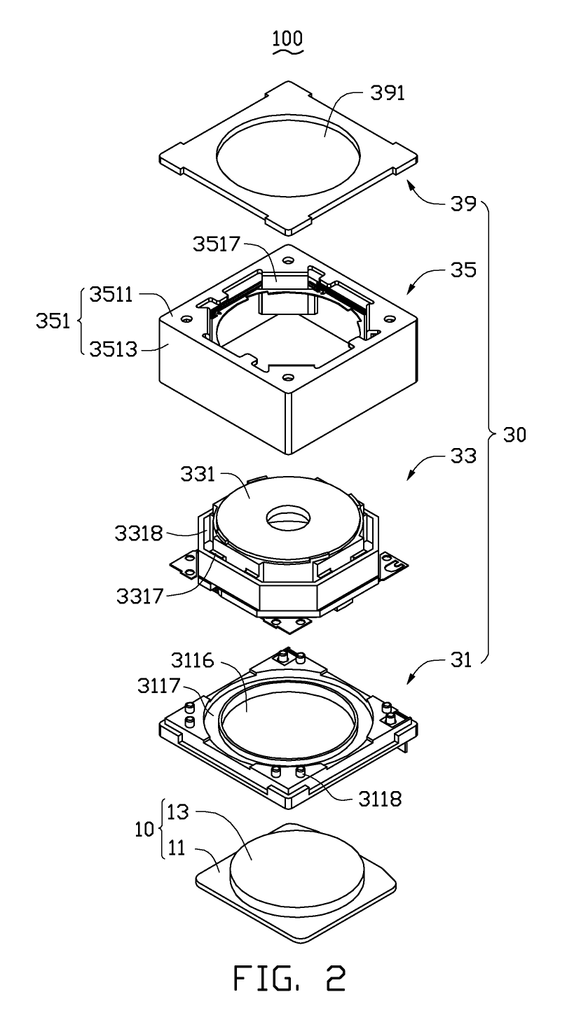

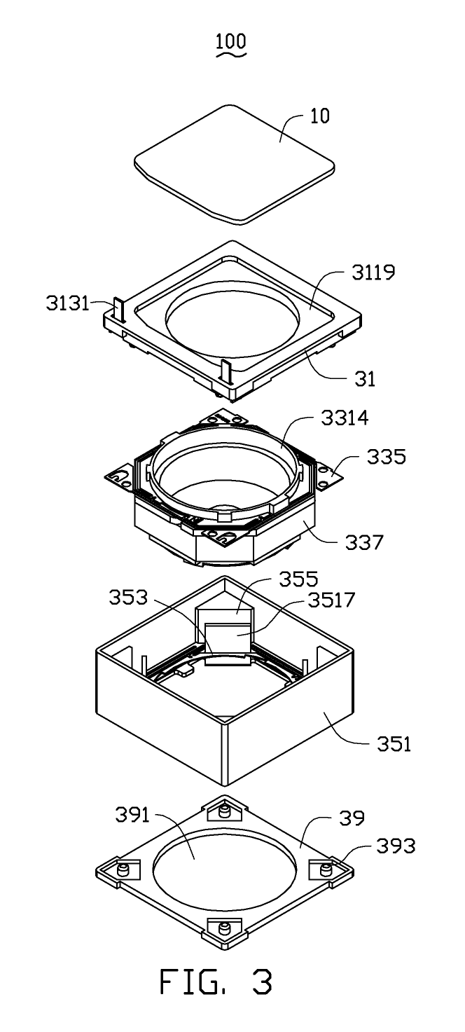

Referring to FIG. 1, an embodiment of a lens module 100 includes an image sensing unit 10 and a voice coil motor 30 is shown. Referring to FIGS. 2 and 3, the image sensing unit 10 includes a base plate 11 and an image sensor 13 positioned on the base plate 11. The voice coil motor 30 is positioned on the base plate 11, and includes a support assembly 31, a piston assembly 33, a fixing assembly 35, and a front cover 39.

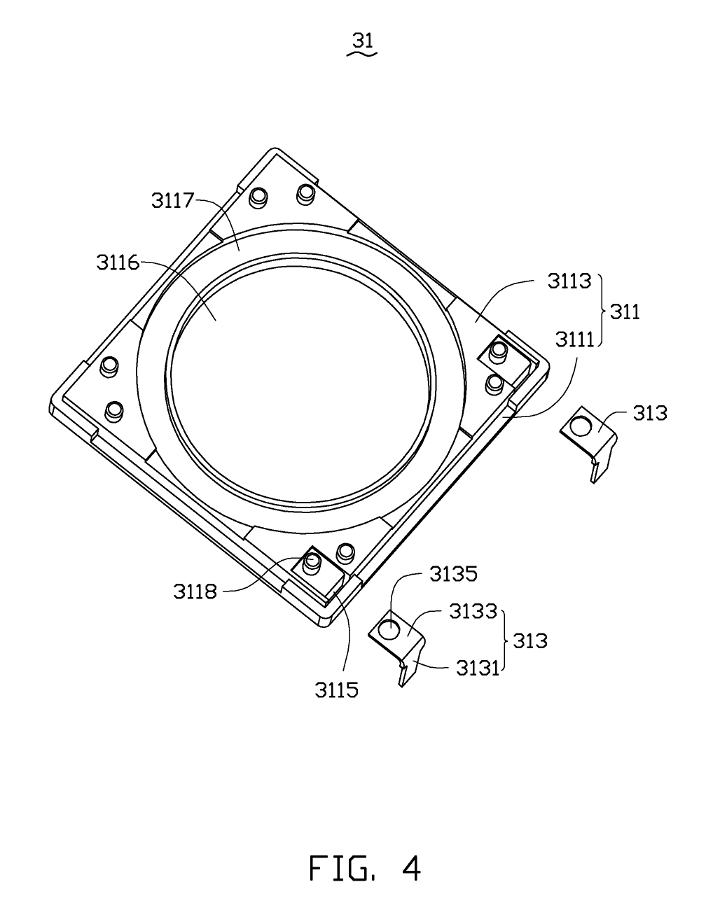

Referring to FIGS. 2 through 4, the support assembly 31 includes a support base 311 and a plurality of connecting pieces 313 positioned on the support base 311. The support base 311 includes a main body 3111 and a plurality of support portions 3113 formed on the main body 3111. The main body 3111 is substantially rectangular, and defines a plurality of assembly holes 3115 in an edge of the main body 3111 for receiving the connecting pieces 313. The main body 3111 defines a circular penetrating hole 3116 in a center portion thereof, and a first assembly groove 3117 in a top surface thereof for receiving the piston assembly 33, and a second assembly groove 3119 in a bottom surface thereof for receiving the base plate 11. The main body 3111 further forms a plurality of positioning poles 3118 on the top surface thereof for positioning the connecting pieces 313 and the piston assembly 33.

The connecting pieces 313 are substantially L-shaped. Each connecting piece 313 includes a connecting portion 3131 and a positioning portion 3133 substantially perpendicularly extending from an end of the connecting portion 3131. The connecting portion 3131 extends through the assembly hole 3115 of the main body 3111, and the positioning portion 3133 defines a receiving hole 3135 for receiving the positioning pole 3118.

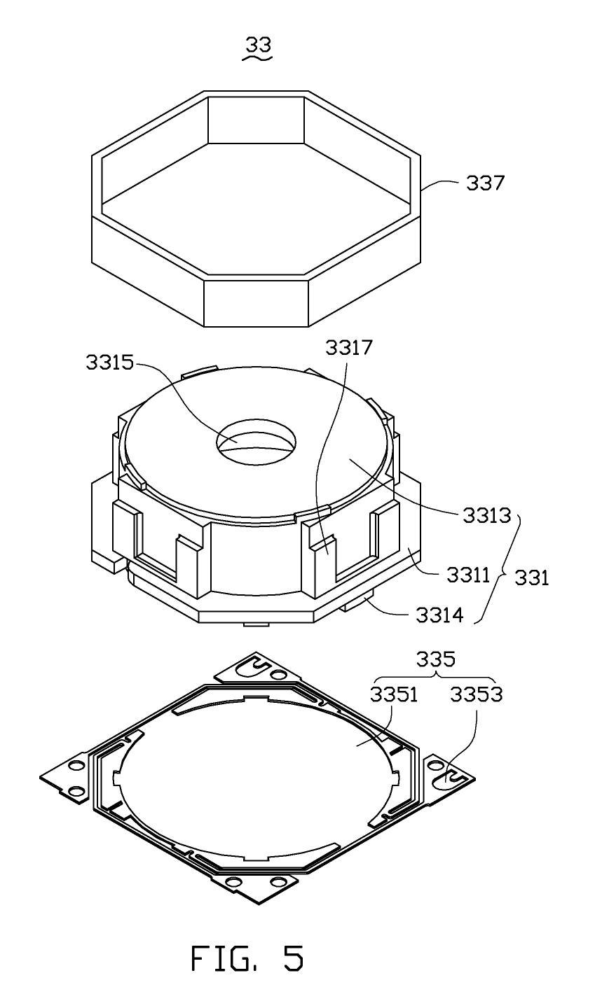

Referring to FIGS. 2, 3 and 5, the piston assembly 33 includes a lens 331, a first elastic piece 335, and a coil 337. The lens 331 includes a main portion 3311, an assembly portion 3313, and a positioning portion 3314. The assembly portion 3313 and the positioning portion 3314 are formed on opposite sides of the main portion 3311. The main portion 3311 is positioned in the first assembly groove 3117 of the support base 311. In the illustrated embodiment, the main portion 3311 is octagonal. The assembly portion 3313 is cylindrical, and defines an assembly hole 3315 penetrating the assembly portion 3313 and the main portion 3311. A plurality of restricting protrusions 3317 is formed on an outer surface of the assembly portion 3313 for positioning the coil 337. The positioning portion 3314 is substantially annular, and used for positioning the first elastic piece 335.

The first elastic piece 335 is substantially rectangular, and defines a through hole 3351. The first elastic piece 335 defines a plurality of positioning holes 3353 for receiving the positioning poles 3118 of the support base 311. The coil 337 is octagonal, and sleeves on the restricting protrusions 3317 of the assembly portion 3313, thereby forming a receiving groove 3318 (see FIG. 2) between the coil 337 and the lens 331. The coil 337 is electrically connected to an outer circuit (not shown).

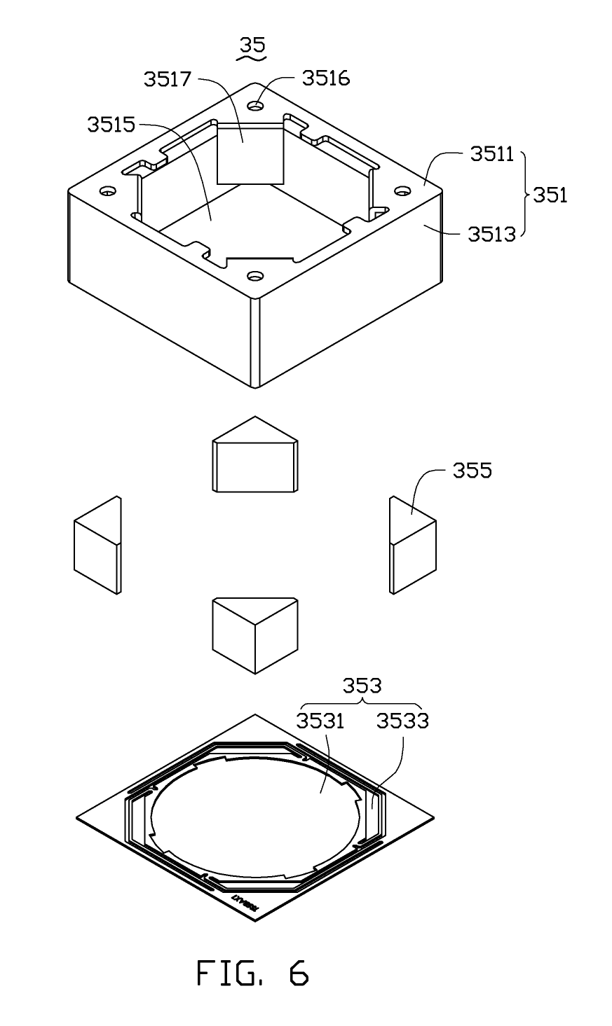

Referring to FIGS. 2, 3 and 6, the fixing assembly 35 includes a fixing frame 351, a second elastic piece 353, and a plurality of magnetic members 355. The fixing frame 351 is positioned on the support portion 3113 of the support base 311, and sleeves on the lens 331. The fixing frame 351 includes a top plate 3511 and a side plate 3513 which is substantially perpendicular extending from an edge of the top plate 3511. The top plate 3511 defines a penetrating hole 3515, and the lens 331 extends through the penetrating hole 3515. The top plate 3511 further defines four connecting holes 3516 in the edge corners thereof. A plurality of resisting portions 3517 extend from an inner rim of the penetrating hole 3515 and towards the inner side of the fixing frame 351. The resisting portions 3517 are received in the receiving groove 3318 of the piston assembly 33.

The second elastic piece 353 is substantially rectangular, and defines a through hole 3531 in a center portion thereof. The second elastic piece 353 further defines a plurality of limiting holes 3533 around the through hole 3531 for receiving the resisting portions 3517.

Each magnetic member 355 has a triangular prism shape, and is positioned in the inner side of the fixing frame 351; and each magnetic member 355 is opposite to one resisting portion 3517. When the resisting portions 3517 are received in the receiving groove 3318 of the piston assembly 33, the magnetic members 355 are arranged opposite to the coil 337. In the illustrated embodiment, the fixing assembly 35 has four magnetic members 355 and four resisting portions 3517. The magnetic members 355 are permanent magnets.

The front cover 39 is fixed on the fixing frame 351, and defines an assembly hole 391 in a center portion thereof. The front cover 39 forms a plurality of fixing poles 393 engaging in the connecting holes 3516 of the fixing frame 351.

Referring to FIGS. 1 through 6, in assembly of the lens module 100, the base plate 11 of the image sensing unit 10 is positioned in the second assembly groove 3119 of the support assembly 31. The first elastic piece 335 sleeves on the positioning portion 3314 of the lens 331, and then the positioning portion 3314 is positioned on the support portion 3113. The coil 337 sleeves on the restricting protrusion 3317 of the assembly portion 3313. The magnetic members 355 are positioned in the inner side of the fixing frame 351. The second elastic piece 353 is positioned on the resisting portions 3517 of the fixing frame 351, and abuts the magnetic members 355. The fixing frame 351 sleeves on the lens 331, with the resisting portions 3517 engaging in the receiving groove 3318 of the lens 331. Then the magnetic members 355 are arranged opposite to the coil 337. The front cover 39 is fixed on the fixing frame 351, with the lens 331 extending through the assembly hole 391 of the front cover 39.

In use, the coil 337 is electrically connected to the outer circuit. As a result of current applied, a magnetic force acts on the coil 337 due to the magnetic field formed by the four magnetic members 355. Then, the lens 331 is driven to move up along the resisting portions 3517. When the coil 337 is disconnected from the outer circuit, the magnetic force ceases, and thus the lens 331 will move down along the resisting portions 3517 simply due to force of gravity.

In assembly of the lens module 100, the coil 337 of the voice coil motor 30 is sleeved on the lens 331, the resisting portions 3517 of the fixing frame 351 is engaged in the receiving groove 3318, and the fixing frame 351 is positioned on the support base 311. Therefore, the lens module 100 is very easily assembled together, and there is no need to machine a plurality of threaded portions on the lens 331 and the piston assembly 33 as found in the lens module of related art, thereby resulting in higher assembly efficiency.

In alternative embodiments, the support assembly 31 can be omitted, and the image sensing unit 10 can be directly positioned on the fixing assembly 35. The fixing assembly 35 may have only one magnetic member 355 or more than two magnetic members 355. The fixing frame 351 may form only one resisting portion 3517 or have more than two resisting portions 3517.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A voice coil motor, comprising:
a fixing assembly comprising a fixing frame and at least one magnetic member positioned on the fixing frame; and
a piston assembly movably received in the fixing assembly, and the piston assembly comprising a lens and a coil sleeved on the lens;
wherein the coil and the lens cooperatively defines a receiving groove; the fixing frame forms at least one resisting portion; the fixing frame sleeves on the lens with the at least one resisting portion engaging in the receiving groove, such that the coil together with the lens are capable of moving along the at least one resisting portion by a magnetic force generated by the at least one magnetic member.

2. The voice coil motor of claim 1, further comprising a support assembly fixed to the piston assembly, wherein the support assembly comprises a support base, the support base defines a first assembly groove in a top surface thereof, and the lens is positioned in the first assembly groove of the support base.

3. The voice coil motor of claim 2, wherein the support base forms a plurality of positioning poles; the piston assembly comprises a first elastic piece, and the first elastic piece sleeves on the lens, and defines a plurality of positioning holes for receiving the positioning poles of the support base.

4. The voice coil motor of claim 2, wherein the fixing frame comprises a top plate and a side plate substantially perpendicular extending from an edge of the top plate; the top plate defines a penetrating hole, and the lens extends through the penetrating hole; the at least one resisting portion extends from an inner rim of the penetrating hole and towards the inner side of the fixing frame.

5. The voice coil motor of claim 4, wherein the fixing assembly further comprises a second elastic piece, the second elastic piece defines at least one limiting hole, and the at least one resisting portion engaging in the at least one limiting hole; the second elastic piece is positioned between the top plate and the at least one magnetic member.

6. The voice coil motor of claim 4, further comprising a front cover fixed on the top plate of the fixing frame.

7. The voice coil motor of claim 1, wherein a plurality of restricting protrusions are formed on an outer surface of the lens for positioning the coil.

8. The voice coil motor of claim 1, wherein the at least one magnetic member has a triangular prism shape, and is positioned in the inner side of the fixing frame; the at least one magnetic member is opposite to the at least one resisting portion.

9. A lens module, comprising:
an image sensing unit comprising a base plate and an image sensor positioned on the base plate;
a voice coil motor positioned on the image sensing unit, comprising:
a fixing assembly comprising a fixing frame and at least one magnetic member positioned on the fixing frame; and
a piston assembly movably received in the fixing assembly, and the piston assembly comprising a lens and a coil sleeved on the lens;
wherein the base plate is fixed on the fixing frame, and the image sensor is opposite to the lens; the coil and the lens cooperatively defines a receiving groove; the fixing frame forms at least one resisting portion; the fixing frame sleeves on the lens with the at least one resisting portion engaging in the receiving groove, such that the coil together with the lens are capable of moving along the at least one resisting portion by a magnetic force generated by the at least one magnetic member.

10. The lens module of claim 9, further comprising a support assembly fixed to the piston assembly, wherein the support assembly comprises a support base, the support base defines a first assembly groove in a top surface thereof, and the lens is positioned in the first assembly groove of the support base.

11. The lens module of claim 10, wherein the support base forms a plurality of positioning poles; the piston assembly comprises a first elastic piece, and the first elastic piece sleeves on the lens, and defines a plurality of positioning holes for receiving the positioning poles of the support base.

12. The lens module of claim 10, wherein the fixing frame comprises a top plate and a side plate substantially perpendicular extending from an edge of the top plate; the top plate defines a penetrating hole, and the lens extends through the penetrating hole; the at least one resisting portion extends from an inner rim of the penetrating hole and towards the inner side of the fixing frame.

13. The lens module of claim 12, wherein the fixing assembly further comprises a second elastic piece, the second elastic piece defines at least one limiting hole, and the at least one resisting portion engaging in the at least one limiting hole; the second elastic piece is positioned between the top plate and the at least one magnetic member.

14. The lens module of claim 12, further comprising a front cover fixed on the top plate of the fixing frame.

15. The lens module of claim 9, wherein a plurality of restricting protrusions are formed on an outer surface of the lens for positioning the coil.

16. The lens module of claim 9, wherein the at least one magnetic member has a triangular prism shape, and is positioned in the inner side of the fixing frame; the at least one magnetic member is opposite to the at least one resisting portion.
